(19) United States
(12) Patent Application Publication
(10) Pub. No.: US 2014/0174592 A1
(43) Pub. Date: Jun. 26, 2014

(54) FILLING OF STORAGE CONTAINERS WITH A COMPRESSED MEDIUM

(71) Applicants: Robert Adler, Gerasdorf (AT); Rolf-Harald Helmschrott, Wolfratshausen (DE); Anton Wellenhofer, Hohenschaftlam (DE); Helmut Hoennicke, Dresden (DE); Stefanie Epple, Esslingen (DE); OLof Källgren, Deisenhofen (DE); Walther Ambros, Hilqertshausen (DE); Wolfgang Dörner, Munchen (DE)

(72) Inventors: Robert Adler, Gerasdorf (AT); Rolf-Harald Helmschrott, Wolfratshausen (DE); Anton Wellenhofer, Hohenschaftlam (DE); Helmut Hoennicke, Dresden (DE); Stefanie Epple, Esslingen (DE); OLof Källgren, Deisenhofen (DE); Walther Ambros, Hilqertshausen (DE); Wolfgang Dörner, Munchen (DE)

(21) Appl. No.: 13/821,463

(22) PCT Filed: Sep. 13, 2011
(86) PCT No.: PCT/EP11/04593

§ 371 Date: Mar. 5, 2014

(30) Foreign Application Priority Data
Sep. 21, 2010 (JP) 10 2010 046 120.2

(51) Int. Cl. F17C 5/00

(52) U.S. Cl. CPC F17C 5/007
USPC 141/4; 141/197

(57) ABSTRACT

A method and an arrangement for filling a second storage container with compressed hydrogen or helium from a first storage container are described, wherein the first and the second storage containers are connected via at least one line, in which at least one valve is disposed.

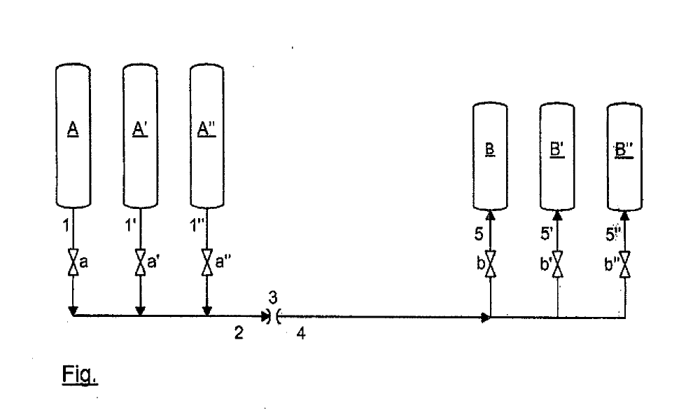

According to the invention, a switching valve (b, b′, b″) controlled by its own medium or a foreign medium is used as a valve, wherein the set pressure of the switching valve (b, b′, b″) is fixed by the maximum permissible operating pressure of the second storage container (B, B′, B).

The present invention relates to a method and an arrangement for filling a second storage container with compressed hydrogen or compressed helium from a first storage container, wherein the first and the second storage containers are connected via at least one line, in which at least one valve is disposed.

Generic methods and arrangements for filling a second storage container with compressed hydrogen from a first storage container are used for example in the filling of the storage container or containers of a hydrogen filling station by means of so-called hydrogen trailers.

In the methods belonging to the prior art for filling a second storage container with compressed hydrogen from a first storage container, a control valve controlled by its own medium is disposed in the line via which the storage containers are connected to one another.

The through-flow of hydrogen from the first to the second storage container and therefore the filling time are limited by the following criteria:
control characteristic of the control valve
Cv/Kv value of the control valve
pressure difference between the first storage container and the second storage container or storage container to be filled.

The actual filling time has not been of crucial importance hitherto, since the storage volume of present hydrogen trailers is only sufficient to supply one or at most two customers with hydrogen. In future, however, hydrogen trailers will be used, wherein the storage capacity is two to three times as high, so that a hydrogen trailer can supply a plurality of customers with hydrogen; in these cases, the filling time increases in importance for obvious reasons.

On account of their control characteristic, back-pressure control valves controlled by their own medium already begin to close when the pressure after the valve has risen to 90 to 95% of the set closing pressure. If the pressure controller is set for example to the maximum permissible operating pressure of the container to be filled, the controller begins to close when 90 to 95% of the maximum permissible operating pressure of the storage container to be filled is reached inside the second storage container to be filled. This behaviour is disadvantageous, since the storage volumes of the pressure containers to be filled are usually comparatively large and consequently the filling time is excessively lengthened on account of the control behaviour of the control valve.

It is also a disadvantage with the known control valves that they have a comparatively small Cv/Kv value.

Current hydrogen trailers store compressed hydrogen under a pressure of approx. 200 bar. With a storage capacity of 34 m³, approx. 600 kg of hydrogen can be transported with such a hydrogen trailer. After the connection of such a hydrogen trailer to the storage container or containers of the hydrogen customer or consumer—it involves here for example a hydrogen filling station, the filling procedure of the storage container or containers, which have a maximum permissible operating pressure of 50 bar and a storage volume of the order of magnitude of 100 m³, takes approx. 1.5 hours.

The problem of the present invention is to provide a generic method and a generic arrangement for filling a second storage container with compressed hydrogen or compressed helium from a first storage container, which avoid the aforementioned drawbacks.

A method is indicated for the solution to this problem, said method being characterised in that a switching valve controlled by its own medium or a foreign medium is used as a valve, wherein the set pressure of the switching valve is fixed by the maximum permissible operating pressure of the second storage container.

This means that a pressure value, which ideally corresponds to the maximum permissible operating pressure of the storage container to be filled, is selected as the set pressure of the switching valve, wherein deviations between 0 and 1% can be tolerated. The use of a switching valve controlled by its own medium or a foreign medium had not hitherto been considered, since the technical experts assumed that a more rapid filling time offered no advantages. With the use of a switching valve controlled by its own medium or a foreign medium, the filling times can be reduced by a factor of >2, the boundary conditions otherwise remaining unchanged. This is due, amongst other things, to the fact that switching valves with greater Cv/Kv values can be obtained and the hydrogen through-flow quantity is no longer limited by the design of the valve used.

The arrangement according to the invention for filling a second storage container with compressed hydrogen or helium from a first storage container is characterised in that the valve is a switching valve controlled by its own medium or a foreign medium, wherein the set pressure of the switching valve is fixed by the maximum permissible operating pressure of the second storage container.

Further advantageous embodiments of the method according to the invention and the arrangement according to the invention, which represent subject-matters of the dependent claims, are characterised in that
the set pressure of the switching valve is not more than 5% below the maximum operating pressure of the second storage container, preferably equal to the maximum operating pressure of the second storage container,
inasmuch as a plurality of second storage containers are filled with compressed hydrogen or compressed helium from one or more first storage containers, a separate switching valve controlled by its own medium or a foreign medium is assigned to at least one of the second storage containers, preferably to all the second storage containers, and
the compressed hydrogen or the compressed helium is stored in the first storage container or containers at a pressure of at least 400 bar and/or in the second storage container or containers at a pressure of at least 50 bar.

The method according to the invention and the arrangement according to the invention for filling a second storage container with compressed hydrogen or compressed helium from a first storage container are explained in greater detail below with the aid of the example of embodiment represented in the figure.

Represented in the figure are three first storage containers A-A″ and three second storage containers B-B″. In practice, an arbitrary number of first and/or second storage containers can in principle be provided. The three first storage containers A-A″ stand for example for a hydrogen trailer. Hydrogen trailers or storage equipment for such trailers are currently being tested, which make it possible to store hydrogen under a pressure of up to 500 bar and over. Approx. 1100 kg of hydrogen can thus be transported with a storage volume of 35 to 40 m³. Second storage containers B-B″ represented in the figure serve for example to store the hydrogen in a hydrogen filling station. The compressed hydrogen is stored in the latter under a pressure between 50 and 200 bar.

Each of the three first storage containers A-A″ comprises a removal line 1-1″, in which a control valve a-a″ is provided in each case. The aforementioned lines 1-1″ emerge into a common removal line 2. Provided at the hydrogen filling station is a central filling line 4, which splits up into a plurality of filling lines 5-5″ assigned to second storage containers B-B″. The connection between the hydrogen trailer and the hydrogen filling station takes place via a coupling 3 of removal line 2 with filling line 4.

During the filling procedure, first storage containers A-A″ are connected individually and one after the other to second storage container B to be filled first. The hydrogen through-flow is detected via valve b and, when a (adjustable) limiting value is fallen below, a change-over takes place to the next first storage container B′. The change-over can take place manually or automatically. In order to avoid overfilling of the storage container to be filled, a suitable warning system should be provided, which interrupts the filling procedure by closing the switching valve.

In contrast with previous filling procedures, the device by means of which blowing-off of the hydrogen takes place in the event of a malfunction of the control valve can be considerably reduced, because now only one blow-off device is required, via which any small leakage flows that may occur with the closed switching valve can be carried away.

In order to be able to store the compressed hydrogen in the first storage container or containers at a pressure of 500 bar, novel pressure containers need to be used. The latter are made of a carbon material and comprise a metallic inliner, preferably an aluminium inliner, or a non-metallic (plastic) inliner. In order to increase the efficiency, the compressed hydrogen is stored in the second storage container or containers at a pressure between 40 and 200 bar. This advantageously takes place in commonly used standard pressure containers or tanks.

The method according to the invention and the arrangement according to the invention for filling a second storage container with compressed hydrogen or compressed helium from a first storage container enable the achievement of shorter filling times, since the through-flow quantity of the hydrogen or helium being transferred can be increased by the use of a switching valve.

1. A method for filling a second storage container with compressed hydrogen or compressed helium from a first storage container, wherein the first and the second storage containers are connected via at least one line, in which at least one valve is disposed, characterised in that a switching valve controlled by its own medium or a foreign medium is used as a valve, wherein the set pressure of the switching valve is fixed by the maximum permissible operating pressure of the second storage container.

2. The method according to claim 1, characterised in that the set pressure of the switching valve is not more than 5% below the maximum operating pressure of the second storage container.

3. The method according to claim 1, wherein a plurality of second storage containers are filled with compressed hydrogen or compressed helium from one or more first storage containers, characterised in that a separate switching valve controlled by its own medium or a foreign medium is assigned to at least one of the second storage containers.

4. The method according to claim 1, characterised in that the compressed hydrogen or the compressed helium is stored in the first storage container or containers at a pressure of at least 400 bar.

5. The method according to claim 1, characterised in that the compressed hydrogen or the compressed helium is stored in the second storage container or containers at a pressure of at least 50 bar.

6. A system for filling a second storage container with compressed hydrogen or compressed helium from a first storage container, wherein the first and the second storage containers are connected via at least one line, in which at least one valve is disposed, characterised in that the valve is a switching valve controlled by its own medium or a foreign medium, wherein the set pressure of the switching valve is fixed by the maximum permissible operating pressure of the second storage container.

7. The system according to claim 6, characterised in that the set pressure of the switching valve is not more than 5% below the maximum operating pressure of the second storage container.

8. The system according to claim 6, wherein a plurality of second storage containers are filled with compressed hydrogen or compressed helium from one or more first storage containers, characterised in that a separate switching valve controlled by its own medium or a foreign medium is assigned to at least one of the second storage containers.

9. The method according to claim 2, characterised in that the set pressure of the switching valve is equal to the maximum operation pressure of the second storage container.

10. The method according to claim 3, characterised in that a separate switching valve controlled by its own medium or a foreign medium is assigned to all the second storage containers.

11. The system according to claim 7, characterised in that the set pressure of the switching valve is equal to the maximum operation pressure of the second storage container.

12. The system according to claim 8, characterised in that a separate switching valve controlled by its own medium or a foreign medium is assigned to all the second storage containers.
